(19) United States
(12) Patent Application Publication
(10) Pub. No.: US 2024/0140574 A1
(43) Pub. Date: May 2, 2024

(54) SAFETY SYSTEM FOR OFFSHORE WIND TURBINE SUPPORTED BY A FLOATING FOUNDATION

(71) Applicant: Siemens Gamesa Renewalble Energy A/S, Brande (DK)

(72) Inventor: Soeren Adrian Schmidt, Vejle (DK)

(73) Assignee: Siemens Gamesa Renewable Energy A/S, Brande (DK)

(21) Appl. No.: 18/280,502

(22) PCT Filed: Mar. 11, 2022
(86) PCT No.: PCT/EP2022/056392

§ 371 Date: Sep. 6, 2023

(30) Foreign Application Priority Data
Mar. 19, 2021 (EP) 21163627.9

(51) Int. Cl. B63B 79/30; B63B 21/20; B63B 21/50; B63B 35/44

(52) U.S. Cl. CPC B63B 79/30; B63B 21/20; B63B 21/50; B63B 35/44; B63B 2021/203; B63B 2035/446; B63B 2241/22

(57) ABSTRACT

A safety system for an offshore wind turbine supported by a floating foundation provided. The floating foundation being secured to a plurality of anchors at a seabed by a corresponding plurality of mooring lines. The safety system includes a safety controller and at least one conductive wire per mooring line, each conductive wire being configured to extend from the safety controller along a mooring line to the corresponding anchor at the seabed and back to the safety controller. The safety controller is configured to determine whether each of the conductive wires is intact or broken.

### CROSS-REFERENCE TO RELATED APPLICATIONS

This application claims priority to PCT Application No. PCT/EP2022/056392, having a filing date of Mar. 11, 2022, which claims priority to European Application No. 21163627.9, having a filing date of Mar. 19, 2021, the entire contents both of which are hereby incorporated by reference.

### FIELD OF TECHNOLOGY

The following relates to the field of wind turbines, in particular to safety systems for an offshore wind turbine supported by a floating foundation, the floating foundation being secured to a plurality of anchors at a seabed by a corresponding plurality of mooring lines. The following further relates to an offshore wind turbine comprising such a safety system, and a method of providing safety for an offshore wind turbine supported by a floating foundation, the floating foundation being secured to a plurality of anchors at a seabed by a corresponding plurality of mooring lines.

### BACKGROUND

As traditional offshore wind turbine foundations on fixed foundations are limited to shallow water with a maximum depth of approximately 70 to 100 meters, the areas for installation are limited. Therefore, floating foundation types are being developed to unlace the full potential of offshore wind power by allowing installation at water depths of 100 meters and more. With the introduction of these new foundation types comes the need for safely securing the turbine to the seabed. This is typically solved by the use of mooring lines and seabed anchors. Securing the turbine foundation serves the purpose of keeping the turbine in place, and also that of providing structural stability of the wind turbine and foundation structure during operation. Due to the thrust on the wind turbine rotor during operation, in case of failure in the mooring lines very dangerous situations in which the wind turbine may overturn and fall into the sea may occur.

Accordingly, there may be a need for a safety system capable of reliably securing a safe operation of a floating foundation of a floating wind turbine to prevent the wind turbine from overturning and falling into the sea.

### SUMMARY

An aspect relates to a safety system for an offshore wind turbine supported by a floating foundation. The floating foundation is secured to a plurality of anchors at a seabed by a corresponding plurality of mooring lines. The safety system thus comprises the mooring lines and a safety controller,

wherein each of the mooring lines is equipped with at least a first conductive wire and a second conductive wire. The term “conductive wire” includes any conductive element being suitable to directly or indirectly transmit an information signal in form of electrons or photons, e.g., may be embodied as an electrical cable or a light conductor, and in particular may not necessarily be configured to transmit significant electrical power (e.g., larger than 1 kW). The first conductive wire and the second conductive wire are configured to extend from the safety controller along the respective mooring line to the corresponding anchor at the seabed and back to the safety controller. Furthermore, the safety controller is configured to feed a first predetermined signal into the first conductive wire and to feed a second predetermined signal into the second conductive wire, wherein the first predetermined signal and the second predetermined signal are different from each other with respect to a respective frequency, phase and/or duty cycle. In addition, the safety controller is configured to individually monitor the first conductive wire and the second conductive wire, to determine whether the first signal and the second signal have been mixed, and to determine whether each of the conductive wires is intact or broken, and to issue an alarm signal if it is determined that the first conductive wire and the second conductive wire are broken.

This aspect of embodiments of the invention are based on the idea that at least two conductive wires are provided for each mooring line such that if the mooring line breaks, the conductive wires also break. Hence, as long as at least one conductive wire of the plurality of wires is intact, it can be assumed that this is also the case for the corresponding mooring line. If the safety controller determines that a conductive wire is broken, e.g., that an electric circuit formed by at least one of the plurality of conductive wires is broken, the safety controller issues a notification signal such that corresponding safety measures can be taken to prevent the wind turbine from being damaged or causing danger. In fact, the safety controller is configured to determine a respective first monitored signal from the first predetermined signal and a respective second monitored signal from the second predetermined signal, and to issue a notification signal if only one monitored signal, and not all of the monitored signals, substantially differs from the respective predetermined signal. The term “substantially” is to be understood such that the skilled person is indeed expecting that a monitored (return-)signal would differ from the respective predetermined feed-signal due to expectable electric influences of the environment into the conductive wire (length of the wire, conductivity of the environment, etc.). However, if detected differences between feed-signal and monitored signal go beyond the expected differences, then substantial differences as understood in the context of embodiments of the invention are present. By equipping each mooring line with at least two conductive wires, additional safety can be assured by the corresponding redundancy.

According to a further embodiment of the invention, the alarm signal is a shutdown signal. The shutdown signal causes a wind turbine to immediately pitch the rotor blades out of the wind and to shut down the generator, in order to reduce the impact of the wind on the wind turbine structural elements.

According to an embodiment, the fact if only one, and not all of the monitored signals, substantially differs from the respective predetermined signal is determined by applying a predetermined or adaptable deviation threshold to the comparison of a respective monitored signal with the respective predetermined signal. If the difference exceeds the deviation threshold, then the notification signal is issued.

According to an embodiment, the predetermined signal is a pulsed signal having at least one of a predetermined frequency, a predetermined phase, and a predetermined duty cycle. In other words, the predetermined signal is characterized by having a predetermined frequency and/or a predetermined phase and/or a predetermined duty cycle, and thus recognizable.

By feeding different predetermined signals (i.e., signals having different frequency and/or phase and/or duty cycle) to each of the conductive wires associated with the same mooring line, it is possible to individually monitor each of the redundant conductive wires and furthermore to determine whether the signals have been mixed, e.g., due to electrical contact between two or more conductive wires.

According to a further embodiment of the invention, the at least one conductive wire or all conductive wires per mooring line is/are embodied as an electrical cable or as an optical cable, configured to extend along the mooring line.

The wires may in particular be fastened to the mooring line, e.g., by strips, or it may be wound around the mooring line or even integrated into the mooring line.

According to a further embodiment of the invention, the presence of the notification signal results in operating the floating wind turbine with reduced power output. Thus, the safety controller and/or any further control entity of the wind turbine is/are configured operate the wind turbine with reduced power output as a consequence of the notification signal, and/or wherein the notification signal is a power curtailing signal for the wind turbine.

According to a second aspect of embodiments of the invention, there is provided an offshore wind turbine comprising (a) a floating foundation configured to be secured to a plurality of anchors at a seabed by a corresponding plurality of mooring lines, (b) a tower arranged on the floating foundation, (c) a nacelle, a rotor and a generator arranged at an upper end of the tower, and (d) a safety system according to the first aspect or any of the embodiments thereof.

This aspect of embodiments of the invention is based on the same concept as the first aspect discussed above and provides a floating offshore wind turbine that is capable of immediately detecting and reacting on a broken mooring line. Embodiments of the first aspect and combinations thereof apply analogously to the second aspect.

According to a third aspect of embodiments of the invention, a method for operating a wind turbine pursuant to the second aspect is disclosed, the method comprises the following steps: a step of feeding a first predetermined signal into the first conductive wire and of feeding a second predetermined signal into the second conductive wire, wherein the first predetermined signal and the second predetermined signal are different from each other with respect to a respective frequency, phase and/or duty cycle, a step of individually monitoring the first conductive wire and the second conductive wire, for example by measuring an electric or optical signal on the other end of the respective conductive wire, a step of determining whether the first signal and the second signal have been mixed, and/or whether each of the conductive wires is intact or broken, and a step of issuing an alarm signal, if it is determined that the first conductive wire and the second conductive wire (241b, 242b, 24nb) are broken, in particular wherein the alarm signal is a shutdown signal.

In an embodiment, the method comprises the steps of determining a respective first monitored signal from the first predetermined signal and a respective second monitored signal from the second predetermined signal, and issuing a notification signal if only one monitored signal, and not all of the monitored signals, substantially differs from the respective predetermined signal. The step of determining a respective monitored signal can be done by measuring an electric or optical signal on the other end of the respective conductive wire and thereby obtaining the respective monitored signal. The determination whether a substantial difference is present can be performed by comparing the respective feed-signal with the respective monitored signal. The term “substantially” is to be understood such that the skilled person would indeed expecting in a certain extend that a monitored (return-)signal would differ from the respective predetermined feed-signal, e.g., due to expectable electric influences of the environment into an electric cable (length of the wire, conductivity of the environment, etc.). However, if detected differences between feed-signal and monitored signal go beyond the expected differences, then substantial differences as understood in the context of embodiments of the invention are present.

The third aspect of embodiments of the invention is based on the same concept as the first and second aspects discussed above and provides a method for operating a floating offshore wind turbine that is capable of immediately detecting and reacting on a broken mooring line. Embodiments of the first and second aspect and combinations thereof apply analogously to the third aspect.

According to an embodiment, the method comprises a step of comparison of respective feed-signal with the respective monitored signal while applying a predetermined or adaptable deviation threshold to the comparison of a respective monitored signal with the respective predetermined signal. If the difference exceeds the deviation threshold, then the notification signal is issued.

It is to be understood that analogue method steps for embodiments of the system having three or four conductive wires are disclosed within the context of the overall disclosure, too.

Embodiments of the present invention further relate to a computer program product (non-transitory computer readable storage medium having instructions, which when executed by a processor, perform actions) comprising instructions which, when the program is executed by a computer, for example the controller, cause the computer to carry out the described method according to the third aspect. In addition, a computer-readable storage medium is proposed having stored thereon such a computer program product. Hence, the inventive computer program product and the storage medium bring up the above-described advantages as well.

The computer program product may be implemented as computer-readable instruction code in any suitable programming language and/or machine language, such as JAVA, C++, C #, and/or Python. The computer program product may be stored on a computer-readable storage medium such as a data disk, a removable drive, volatile or non-volatile memory, or a built-in memory/processor. The instruction code may program a computer or other programmable devices such as the controller in order to perform the desired functions. Further, the computer program product may be provided and/or be on a network, such as the internet, from which it may be downloaded by a user as needed. The computer program product may be implemented by software, as well as by one or more special electronic circuits, that is, in hardware or in any hybrid form, that is, by software components and hardware components.

According to a further aspect of embodiments of the invention, there is provided a method of providing safety for an offshore wind turbine supported by a floating foundation, the floating foundation being secured to a plurality of anchors at a seabed by a corresponding plurality of mooring lines. In an embodiment, the method comprises (a) providing a safety controller, (b) providing at least one conductive wire per mooring line, each conductive wire extending from the safety controller along a mooring line to the corresponding anchor at the seabed and back to the safety controller, (c) determining, at the safety controller, whether each of the conductive wires is intact or broken, and (d) issuing an alarm signal if it is determined that a conductive wire is broken.

This aspect of embodiments of the invention are based on the same idea as the first and second aspects described above.

It is noted that embodiments of the invention have been described with reference to different subject matters. In particular, some embodiments have been described with reference to method type claims whereas other embodiments have been described with reference to apparatus type claims. However, a person skilled in the conventional art will gather from the above and the following description that, unless otherwise indicated, in addition to any combination of features belonging to one type of subject matter also any combination of features relating to different subject matters, in particular to combinations of features of the method type claims and features of the apparatus type claims, is part of the disclosure of this document.

The aspects defined above, and further aspects of the present invention are apparent from the examples of embodiments to be described hereinafter and are explained with reference to the examples of embodiments. The invention will be described in more detail hereinafter with reference to examples of embodiments. However, it is explicitly noted that the invention is not limited to the described exemplary embodiments.

### BRIEF DESCRIPTION

Some of the embodiments will be described in detail, with reference to the following figures, wherein like designations denote like members, wherein:

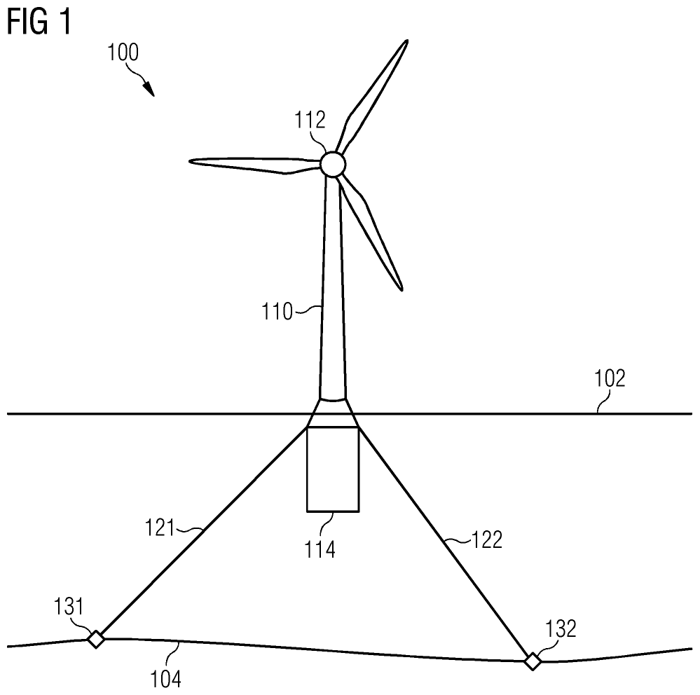

FIG. 1 shows an offshore wind turbine supported by a floating foundation;

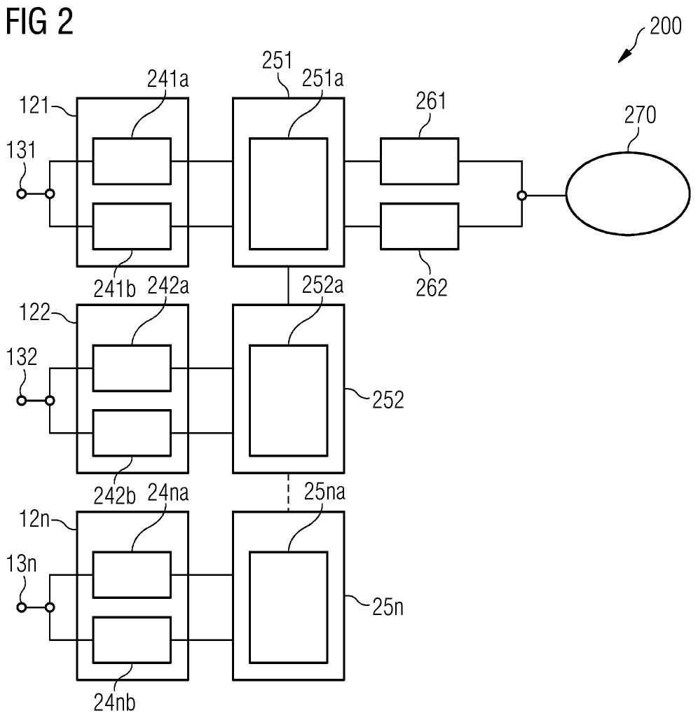

FIG. 2 shows a block diagram of a safety system for an offshore wind turbine supported by a floating foundation according to an embodiment; and

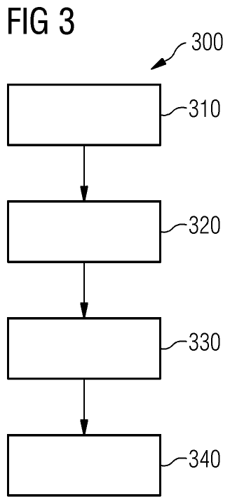

FIG. 3 shows a flowchart of a method of providing safety for an offshore wind turbine supported by a floating foundation according to an embodiment.

### DETAILED DESCRIPTION

The illustration in the drawing is schematic. It is noted that in different figures, similar or identical elements are provided with the same reference numerals or with reference numerals which differ only within the first digit.

FIG. 1 shows an offshore wind turbine 100 supported by a floating foundation 114. The wind turbine 100 comprises a tower 110 supported by the foundation 114 that floats in and below the waterline 102. The tower 110 carries a rotor 112 (with hub and rotor blades) and a nacelle (not shown) at its upper end. The floating foundation is secured to the seabed 104 by mooring lines 121, 122 extending between the foundation 114 and corresponding anchors 131, 132 at the seabed. For reasons of simplicity, FIG. 1 only shows two mooring lines 121, 122 and corresponding anchors 131, 132. It should be understood, however, that any other number of mooring lines and corresponding anchors may be used, such as three, four, five, six, eight, twelve, eighteen or any other number larger than two.

FIG. 2 shows a block diagram of a safety system 200 for the offshore wind turbine 100 supported by the floating foundation 114 according to an embodiment. The plurality of mooring lines 121, 122, 12n are shown schematically as boxes. Each mooring line 121, 122, 12n is equipped with a first conductive wire 241a, 242a, 24na and a second conductive wire 241b, 242b, 24nb extending between a corresponding safety controller module 251, 252, 25n along the mooring line 121, 122, 12n to the corresponding anchor 131, 132, 13n at the seabed 104 and back to the safety controller module 251, 252, 25n. The safety controller module 251 comprises a PL (programmable logic) 251a and is configured to determine whether each of the conductive wires 241a, 241b is intact or broken, and to issue an alarm signal if it is determined that one or both of the conductive wires 241a, 241b is/are broken as this would indicate that the mooring line 121 is broken. The alarm signal will open one or both contactors 261, 262 and result in activation of a safe pitch function 270 which causes the wind turbine controller (not shown) to immediately pitch the rotor blades out of the wind. Similarly, the safety controller module 252 comprises a PL (programmable logic) 252a and is configured to determine whether each of the conductive wires 242a, 242b is intact or broken, and to issue an alarm signal if it is determined that one or both of the conductive wires 242a, 242b is/are broken as this would indicate that the mooring line 122 is broken. Finally, the safety controller module 25n comprises a PL (programmable logic) 25na and is configured to determine whether each of the conductive wires 24na, 24nb is intact or broken, and to issue an alarm signal if it is determined that one or both of the conductive wires 24na, 24nb is/are broken as this would indicate that the mooring line 121 is broken.

As discussed above, each mooring line 121, 122, 12n in the exemplary embodiment shown in FIG. 2 comprises two electrically conducting wires 241a/b, 242a/b, and 24na/b. It is explicitly noted that any number of electrically conducting wires per mooring line may be used. That is, 1, 2, 3, 4 or more conductive wire(s) may be used per mooring line.

The depicted safety controller modules 251, 252, 25n may be implemented as separate safety controller modules or they may represent functional modules of a single safety controller.

In order to determine whether a conductive wire is intact or broken, the corresponding safety controller module may feed a predetermined signal into one end of the conductive wire and determine whether the same predetermined signal is received at the other end of the conductive wire. The predetermined signal may in particular be a pulsed signal having at least one of a predetermined frequency, a predetermined phase, and a predetermined duty cycle. By using different frequencies and/or phases and/or duty cycles for each electrically conducting wire, the reliability of the safety system can be further increased.

FIG. 3 shows a flowchart 300 of a method of providing safety for an offshore wind turbine 100 supported by a floating foundation 114 according to an embodiment, the floating foundation being secured to a plurality of anchors 131, 132, 13n at a seabed 104 by a corresponding plurality of mooring lines 121, 122, 12n. At 310, a safety controller, e.g., in form of safety controller modules 252, 252, 25n as shown in FIG. 2, are provided. At 320, at least two conductive wires 241a, 241b, 242a, 242b, 24na, 24nb are provided per mooring line. Each conductive wire 241a, 241b, 242a, 242b, 24na, 24nb extends from the safety controller along a mooring line 121, 122, 12n to the corresponding anchor 131, 132, 13n at the seabed 104 and back to the safety controller. At 330, it is determined by the safety controller, whether each of the conductive wires 241a, 241b, 242a, 242b, 24na, 24nb is intact or broken. If it is determined that the conductive wires 241a, 241b, 242a, 242b, 24na, 24nb are broken, an alarm signal is issued at 340.

The safety controller 251, 252, 25n is configured to determine a respective first monitored signal from the first predetermined signal fed in on end of the first conductive wire (241a, 242a, 24na) and to determine a respective second monitored signal from the second predetermined signal fed into the second conductive wire (241b, 242b, 24nb). If only one monitored signal, and not all of the monitored signals, substantially differs from the respective predetermined signal, a first notification signal is issued. For example, this notification signal can be used to change the operation of the wind turbine to an operation having a reduced power output. The serves to reduce loads and thrust to the floating foundation 114. Also, the reason of the deviation in the monitored signal can be examined, specifically if the respective mooring line is functioning properly.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A safety system for an offshore wind turbine supported by a floating foundation, the safety system comprising:
a plurality of mooring lines configured for securing the floating foundation to a plurality of anchors at a seabed; and
a safety controller,
wherein each of the plurality of mooring lines is equipped with at least a first conductive wire and a second conductive wire, the first conductive wire and the second conductive wire being configured to extend from the safety controller along a respective mooring line to a corresponding anchor at the seabed and back to the safety controller,
wherein the safety controller is configured to:
feed a first predetermined signal into the first conductive wire and feed a second predetermined signal into the second conductive wire, wherein the first predetermined signal and the second predetermined signal are different from each other with respect to a respective frequency, phase, and/or duty cycle,
individually monitor the first conductive wire and the second conductive wire,
determine whether the first signal and the second signal have been mixed, and/or to determine whether each of the conductive wires is intact or broken, and
issue an alarm signal, if it is determined that the first conductive wire and the second conductive wire are broken, wherein the alarm signal is a shutdown signal.

2. The safety system according to claim 1,
wherein each of the plurality of mooring lines is equipped with a third conductive wire, wherein the third conductive wire is configured to extend from the safety controller along the respective mooring line to the corresponding anchor at the seabed and back to the safety controller, and
wherein the safety controller is configured to feed a third predetermined signal into the third conductive wire.

3. The safety system according to claim 2,
wherein each of the plurality of mooring lines is equipped with a fourth conductive wire, wherein the fourth conductive wire is configured to extend from the safety controller along the respective mooring line to the corresponding anchor at the seabed and back to the safety controller, and
wherein the safety controller is configured to feed a fourth predetermined signal into the fourth conductive wire.

4. The safety system according to claim 2, wherein the third predetermined signal is different from the first predetermined signal and/or from the second predetermined signal, and/or wherein the fourth predetermined signal is different from the first predetermined signal, from the second predetermined signal, and/or from the third predetermined signal.

5. The safety system according to claim 4, wherein the safety controller is configured to:
individually monitor the third conductive wire and/or the fourth conductive wire, and determine whether any of the first signal, the second signal, and of the third signal, or any of the first signal, the second signal, third signal, and of the fourth signal have been mixed with another signal, and/or to determine whether each of the conductive wires is intact or broken.

6. The safety system according to claim 1, wherein the safety controller is configured to:
determine a respective first monitored signal from the first predetermined signal and a respective second monitored signal from the second predetermined signal, and
issue a notification signal if only one monitored signal, and not all of the monitored signals, substantially differs from the respective predetermined signal, and
issue the alarm signal if all of the monitored signals substantially differ from each of the respective predetermined signals.

7. The safety system according to claim 2, wherein the safety controller is configured to:
determine a respective third monitored signal from the third predetermined signal, or a respective third monitored signal from the third predetermined signal and a respective fourth monitored signal from the fourth predetermined signal,
issue a notification signal if only one monitored signal of the entirety of monitored signal substantially differs from the respective predetermined first, second, third, and/or fourth signal, or issue a notification signal if the first monitored signal substantially differs from the first predetermined signal, or if the second monitored signal substantially differs from the second predetermined signal, or if the third monitored signal substantially differs from the third predetermined signal, or if the fourth third monitored signal substantially differs from the fourth predetermined signal.

8. The safety system according to claim 6, wherein the safety controller is configured to determine whether a monitored signal substantially differs from the respective predetermined signal by applying a predetermined or adaptable deviation threshold to the comparison of a respective monitored signal with the respective predetermined signal.

9. The safety system according to claim 6, wherein the safety controller and/or any further local control entity of the wind turbine is/are not configured to initiate a shutdown of the wind turbine based on the notification signal, and/or wherein the notification signal is not a shutdown signal for the wind turbine.

10. The safety system according to claim 6, wherein the safety controller and/or any further control entity of the wind turbine is/are configured operate the wind turbine with reduced power output as a consequence of the notification signal, and/or wherein the notification signal is a power curtailing signal for the wind turbine.

11. The safety system according to claim 1, wherein the first conductive wire and the second conductive wire are arranged with the respective mooring line such that a distance between the first conductive wire and the second conductive wire perpendicular to a longitudinal direction of the respective mooring line is substantially maximized by arranging the first conductive wire and the second conductive wire on opposing portions of the respective mooring line conductive wire.

12. The safety system according to claim 1, wherein the first conductive wire, the second conductive wire and the respective mooring line have a substantially same effective lengthening in a respective longitudinal direction, or wherein the first conductive wire, the second conductive wire and the respective mooring line have the substantially same absolute stretching effectively over an entire length thereof.

13. An offshore wind turbine comprising:
a floating foundation configured to be secured to a plurality of anchors at a seabed by a corresponding plurality of mooring lines,
a tower arranged on the floating foundation,
a nacelle, a rotor and a generator arranged at an upper end of the tower, and
a safety system according to claim 1.

14. A method for operating a floating wind turbine according to claim 1, comprising:
feeding a first predetermined signal into the first conductive wire and feeding a second predetermined signal into the second conductive wire, wherein the first predetermined signal and the second predetermined signal are different from each other with respect to a respective frequency, phase and/or duty cycle,
individually monitoring the first conductive wire and the second conductive wire,
determining whether the first signal and the second signal have been mixed, and/or whether each of the conductive wires is intact or broken, and
issuing an alarm signal if it is determined that the first conductive wire and the second conductive wire are broken, wherein the alarm signal is a shutdown signal.

15. The method according to claim 14, comprising:
determining a respective first monitored signal from the first predetermined signal and a respective second monitored signal from the second predetermined signal, and
issuing a notification signal if only one monitored signal, and not all of the monitored signals, substantially differs from the respective predetermined signal,
and issuing the alarm signal if all of the monitored signals substantially differ from each of the respective predetermined signals.

16. The method according to claim 15, comprising initiating a shutdown of the wind turbine if the alarm signal is issued.

17. The method according to claim 14, comprising the step of operating the wind turbine with reduced power output if the notification signal is issued.

18. A computer program product, comprising a computer readable hardware storage device having computer readable program code stored therein, said program code executable by a processor of a computer system to implement a method according to claim 14.

19. A computer-readable storage medium having store thereon the computer program product according to claim 18.
